(19) United States
(12) Patent Application Publication
(10) Pub. No.: US 2003/0190845 A1
(43) Pub. Date: Oct. 9, 2003

(54) Electrical connector having a contact array which provides inductive cross talk compensation

(75) Inventors: Sterling A. Vaden, Black Mountain, NC (US); Ian Timmins, Round Rock, TX (US)

Correspondence Address: J. DEREL MONTEITH, JR., CARTER & SCHNEDLER, P.A., 56 CENTRAL AVENUE, SUITE 101, P.O. BOX 2985, ASHEVILLE, NC, 28802, US

(73) Assignee: Superior Modular Products Incorporated, Swannanoa, NC (US)

(21) Appl. No.: 10/264,290

(22) Filed: Oct. 3, 2002

Related U.S. Application Data
(60) Provisional application No. 60/328,512, filed on Oct. 10, 2001.

(51) Int. Cl. H01R 24/00

(52) U.S. Cl. 439/676

(57) ABSTRACT

An array of electrical conductors, the array including an input zone, a first inductive cross talk compensation zone downstream from the input zone, and a second inductive cross talk compensation zone downstream from the first inductive cross talk compensation zone, the first inductive cross talk compensation zone of the array being configured to induce corrective mutual inductance therein for reducing cross talk caused by undesirable mutual inductance in the input zone of the array, and the second inductive cross talk compensation zone of the array being configured to induce corrective mutual inductance therein for reducing cross talk caused by undesirable mutual inductance in the input zone of the array and caused by undesirable mutual inductance in the first inductive cross talk compensation zone of the array.

This is a U.S. nonprovisional patent application relating to and claiming the benefit of the U.S. provisional patent application having the serial No. 60/328,512, which was filed in the U.S. Patent & Trademark Office on Oct. 10, 2001.

### BACKGROUND OF THE INVENTION

This invention relates to electrical connectors which are susceptible to cross talk between pairs of conductors.

RJ type TIA plugs and jacks include pairs of closely parallel conductors. At higher frequencies, for example, above 1 MHz, an unacceptable amount of cross talk occurs between the conductors, and between pairs of conductors. This is due to the fact that conductors, including contacts, are closely spaced which encourages both capacitive and inductive couplings. In general, capacitive couplings occur between individual closely spaced conductors, while inductive couplings occur between pairs of closely spaced pairs of conductors.

Cross talk due to capacitance can be alleviated by crossing certain conductors in the jack lead frame or contact array, as taught by U.S. Pat. No. 5,186,647 issued to Denkmann et al, so that in effect, the polarity of the cross talk is reversed, thereby canceling the cross talk. Cross talk cancellation may also be accomplished on a circuit board to which the jack is attached, as taught in U.S. Pat. No. 5,299,956 issued to Brownell et al.

It is also desirable to reduce the inductive component of cross talk. One approach to inductive cross talk reduction is disclosed in U.S. Pat. No. 5,700,167 issued to Pharney et al. The Pharney patent teaches the printing of mirror image facing loops on opposing sides of a circuit board to compensate for inductive cross talk arising in a plug and jack. However, it is desirable to compensate for inductive cross talk as near to the source of the cross talk as possible, that is, as near to the plug and jack contacts as possible.

### SUMMARY OF THE INVENTION

An array of electrical conductors, the array including an input zone, a first inductive cross talk compensation zone downstream from the input zone, and a second inductive cross talk compensation zone downstream from the first inductive cross talk compensation zone, the first inductive cross talk compensation zone of the array being configured to induce corrective mutual inductance therein for reducing cross talk caused by undesirable mutual inductance in the input zone of the array, and the second inductive cross talk compensation zone of the array being configured to induce corrective mutual inductance therein for reducing cross talk caused by undesirable mutual inductance in the input zone of the array and caused by undesirable mutual inductance in the first inductive cross talk compensation zone of the array.

A method for reducing undesirable inductive cross talk in an array of electrical conductors, the method including the steps of providing an array of electrical conductors, configuring the array to include an input zone, a first inductive cross talk compensation zone downstream from the input zone, and a second inductive cross talk compensation zone downstream from the first inductive cross talk compensation zone, configuring the first inductive cross talk compensation zone of the array to induce corrective mutual inductance therein for reducing cross talk caused by undesirable mutual inductance in the input zone of the array, and configuring the second inductive cross talk compensation zone of the array to induce corrective mutual inductance therein for reducing cross talk caused by undesirable mutual inductance in the input zone of the array and caused by undesirable mutual inductance in the first inductive cross talk compensation zone of the array.

A method for reducing undesirable inductive cross talk in an array of electrical conductors, the method including the steps of providing an array of electrical conductors comprising an input zone, a first inductive cross talk compensation zone downstream from the input zone, and a second inductive cross talk compensation zone downstream from the first inductive cross talk compensation zone, inducing undesirable cross talk in the input zone of the array, inducing undesirable cross talk in the first inductive cross talk compensation zone of the array, inducing corrective mutual inductance in the first inductive cross talk compensation zone for reducing cross talk caused by undesirable mutual inductance in the input zone of the array, and inducing corrective mutual inductance in the second inductive cross talk compensation zone for reducing cross talk caused by undesirable mutual inductance in the input zone of the array and caused by undesirable mutual inductance in the first inductive cross talk compensation zone of the array.

### BRIEF DESCRIPTION OF THE DRAWINGS

FIG. 1 is a fragmentary and schematic top plan view of an array of four pairs of conductors oriented in the configuration utilized in a TIA specified plug;

FIG. 2 is a fragmentary and schematic elevational view of a plug inserted into a jack comprising an array of two pairs of conductors configured in accordance with an embodiment of the invention;

FIG. 3 is a fragmentary and schematic perspective view of an array of two pairs of conductors in a jack configured in accordance with an embodiment of the invention as viewed from the rear of the jack;

FIG. 4 is a fragmentary and schematic perspective view of an array of two pairs of conductors in a jack configured in accordance with an embodiment of the invention as viewed from the rear of the jack;

FIG. 5 is a schematic elevational view of an array of two pairs of conductors with vectors drawn between the members of each pair to illustrate the angles of mutual inductance exhibited by the pairs;

FIG. 6 is a fragmentary and schematic elevational view of an array of four pairs of conductors in a jack configured in accordance with an embodiment of the invention;

FIG. 7 is a fragmentary and schematic elevational view of the array shown in FIG. 6, with a facing area in the first inductive cross talk compensation zone of the array shaded;

FIG. 8 is a fragmentary and schematic elevational view of the array shown in FIG. 6, with a facing area in the second inductive cross talk compensation zone of the array shaded;

FIG. 9 is a fragmentary perspective view of an array of four pairs of conductors in a jack configured in accordance with a further embodiment of the invention; and

FIG. 10 is a fragmentary elevational view of the array shown in FIG. 9.

### DETAILED DESCRIPTION

The closely spaced configuration of contacts formed by the four twisted pairs of conductors in a TIA specified plug is shown generally at reference numeral 10 in FIG. 1. In the illustrated and described embodiments of the invention, the standard known by those of ordinary skill in the art as TIA 568B is utilized. However, the invention may be implemented with equal effectiveness in connections designed in accordance with the standard known by those of ordinary skill in the art as TIA 568A, because, as is known by those of ordinary skill in the art, TIA 568A only differs from TIA 568B by orienting the respective conductors comprising Pair 3 in TIA 568B where the respective conductors comprising Pair 2 in TIA 568B are oriented, and vice versa. Therefore, the utilization of TIA 568B herein is for purposes of illustration and not for purposes of limitation, and reference herein to “TIA specifications” refers to both TIA 568A and TIA 568B. Turning now to FIG. 1, in accordance with TIA 568B, Pair 1 (11) is comprised of conductor 4 (11 N) and conductor 5 (11 P), which have negative and positive polarity, respectively; Pair 2 (12) is comprised of conductor 1 (12P) and conductor 2 (12N), which have positive and negative polarity, respectively; Pair 3 (13) is comprised of conductor 3 (13P) and conductor 6 (13N), which have positive and negative polarity, respectively; and Pair 4 (14) is comprised of conductor 7 (14P) and conductor 8 (14N), which have positive and negative polarity, respectively. Since Pair 1 (11) is surrounded by Pair 3 (13), resulting capacitive and inductive couplings are present between them. Furthermore, resulting capacitive and inductive couplings exist between both Pair 1 (11) and Pair 3 (13) and the outer Pair 2 (12) and Pair 4 (14).

In order to control cross talk, it is required that both capacitive and inductive coupling fields be compensated for those induced in the plug, and to a certain extent, in the jack. Capacitive compensation is discussed in the aforementioned Denkmann and Brownell patents, and inductive compensation has been performed typically using the PC board to which the jack is attached, as shown in the Pharney patent. The techniques set forth below will outline how to compensate for inductive cross talk and thus reduce inductive cross talk using various configurations of the contact array in a connector jack, and thus control the inductive couplings between all pairs simultaneously.

Inductive coupling between differential pairs in a three dimensional space is quantified primarily by two fundamental properties. Those properties are the separation distance and the facing area between the pairs. Mutual inductance is directly proportional to the facing area and mutual inductance is inversely proportional to the distance between the facing area.

In addition, the angle between the facing areas is another variable. When the angle between the facing areas is 00, there is maximum mutual inductance. The mutual inductance becomes less as the angle is increased until the angle reaches 90°, at which point the mutual inductance becomes zero. Thus the mutual inductance is a function of the cosine of the angle between the facing areas.

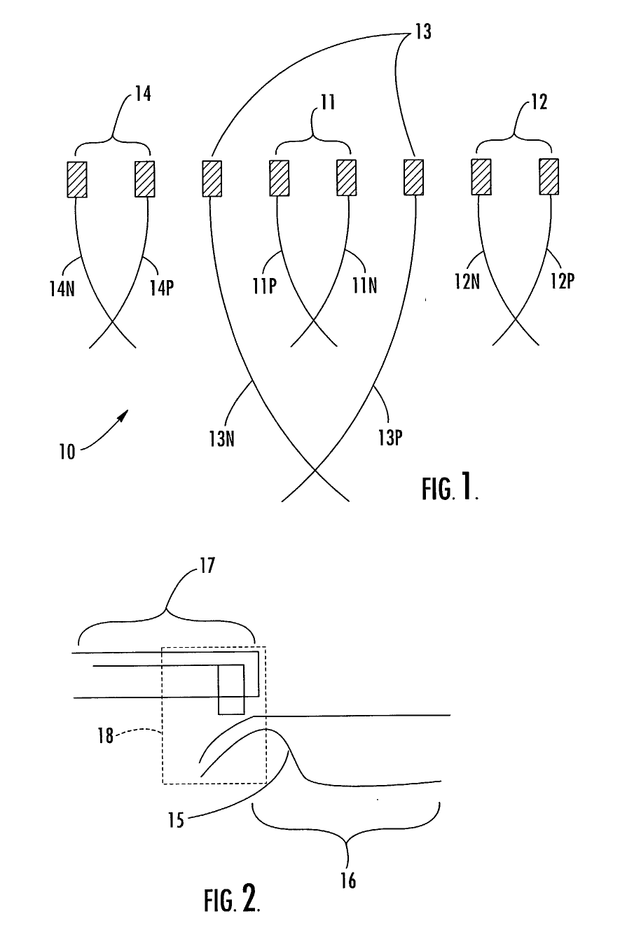

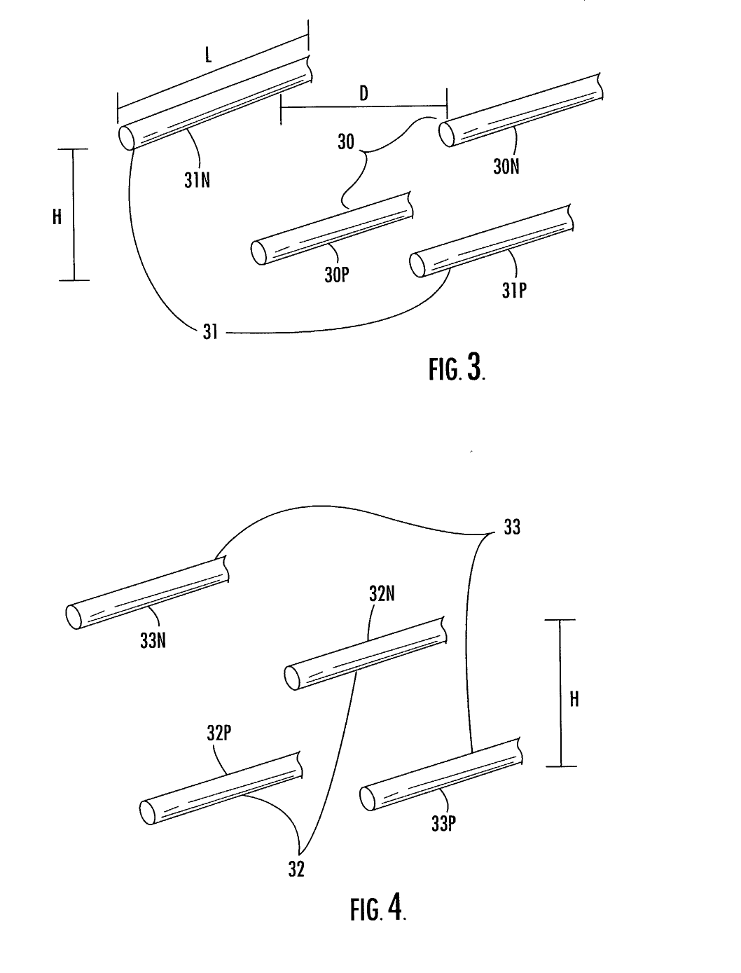

Since the inductance which results in cross talk arising in the plug and to a certain extent in the jack between Pair 1 (11) and Pair 3 (13) can be approximately 1.75 mH, one can create a facing set of loops in the contact array to offset these inductive couplings in the plug and to a certain extent within the jack. This is done by canceling the inductance using loops in the jack contact array. FIG. 2 illustrates an embodiment of a loop 15 within a jack 16 that has received a plug 17, with the intersection of the jack 16 and the plug 17 defining an input zone 18. This loop area will need to be made larger as the distance between the pairs increases.

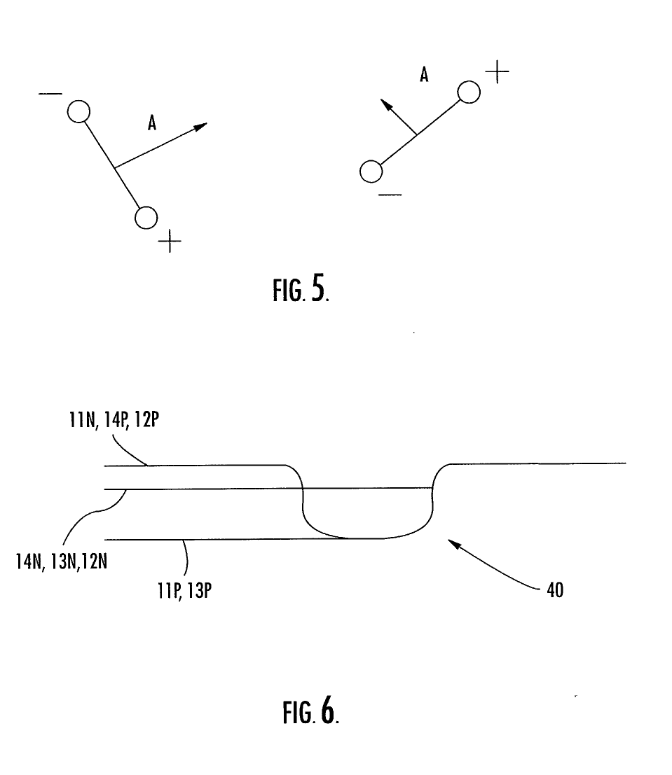

The rear view of a jack may offer more insight into the relationship of the area to distance, which is illustrated in FIG. 3 by two conductor pairs 30, 31 in close proximity with reference to length “L”, distance “D”, and height “H” dimensions. The positive polarity conductors 30P, 31P and negative polarity conductors 30N, 31N of each pair 30, 31 are designated. It is noteworthy that the pins shown in FIG. 3 need not be positioned in a uniform staggering arrangement; for example, see conductor pairs 32, 33, and the positive polarity conductors 32P, 33P and negative polarity conductors 32N, 33N therein, illustrated in FIG. 4. The illustration in FIG. 4 may prove to give decreased cross talk levels and satisfy other physical requirements, however, length may have to be increased as height is decreased. In a situation wherein multiple pairs of transmission lines require compensation due to the introduction of a plug, an arrangement is possible to allow one level of inductive compensation in the jack between Pairs 1 (11) and 3 (13), as well as Pairs 2 (12) and 3 (13) and Pairs 3 (13) and 4 (14), while maintaining reduced cross talk levels between Pairs 1 (11) and 2 (12) and Pairs 1 (11) and 4 (14) with reduced inductive couplings. Embodiments of the invention that help accomplish these objectives are shown in FIGS. 6-10 and are discussed further below.

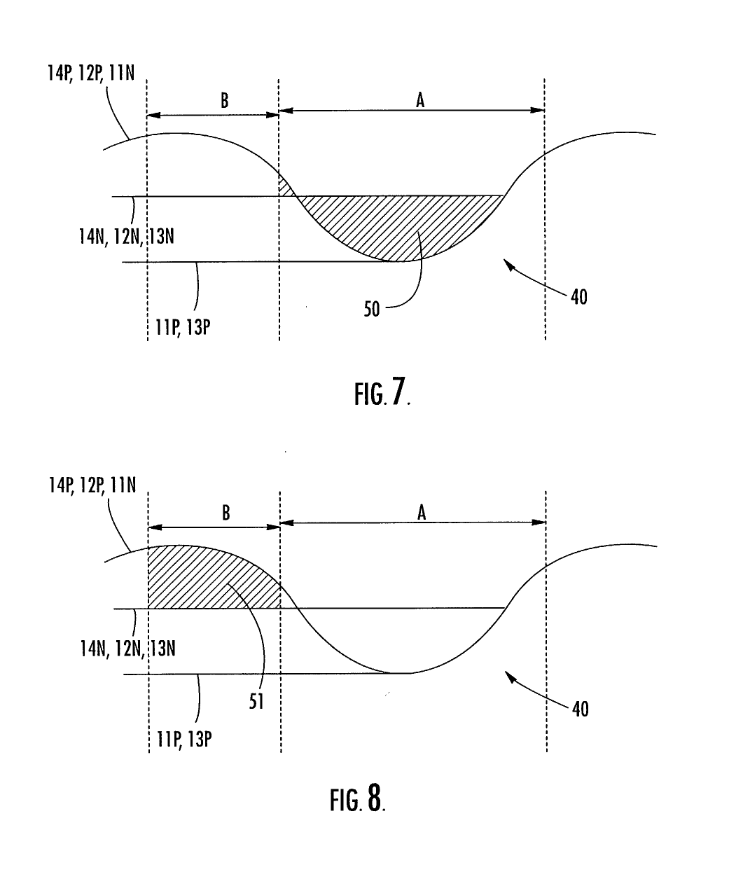

Furthermore, adjustments of facing area allows all pairs to be compensated inductively simultaneously giving reduced levels of cross talk on all pairs. This can be accomplished by changing the direction or angle of the area vectors, as shown in FIG. 5. Therefore, as illustrated in contact array 40 shown in FIG. 6, should Pair 1 (conductors 11N, 11P) and Pair 3 (conductors 13N, 13P) require −1.75 mH and Pairs 1 (11N, 11P) and 2 (conductors 12N, 12P) and Pairs 1 (11N, 11P) and 4 (conductors 14N, 14P) require +0.105 mH, loops can be created with Pairs 1 (11N, 11P) and 3 (13N, 13P) maintained at −1.75 mH. Pairs 3 (13N, 13P) and 2 (12N, 12P) and Pairs 3 (13N, 13P) and 4 (14N, 14P) can then be controlled for inductive compensation of the plug via adjusting the shaded area shown at reference numeral 50 in FIG. 7, which falls within a first inductive compensation zone “A” in the contact array 40. Controlling Pairs 1 (11N, 11P) and 2 (12N, 12P) and Pairs 1 (11N, 11P) and 4 (14N, 14P) can then be made by adjusting the area shown at reference numeral 51 in FIG. 8, which falls within a second inductive compensation zone “B” in the contact array 40.

Conductors 14P and 12P can be raised or lowered to give the correct inductive coupling value to compensate the inductive cross talk in the plug. Using this approach, near ideal inductive compensation can be induced between all pair combination to reduce cross talk levels between pairs for connecting hardware.

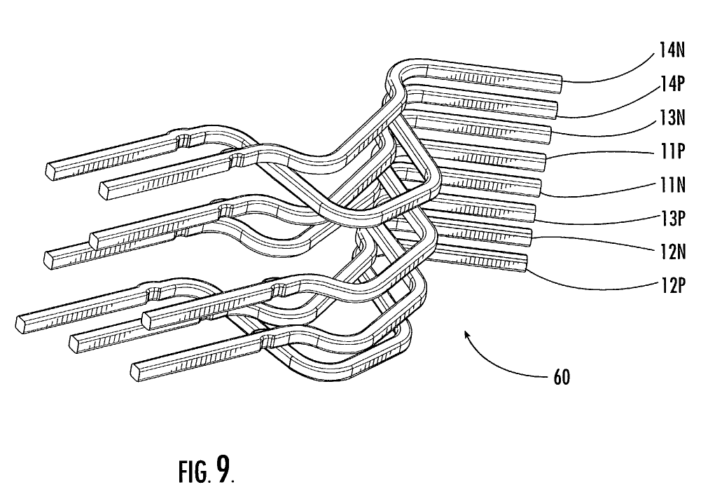

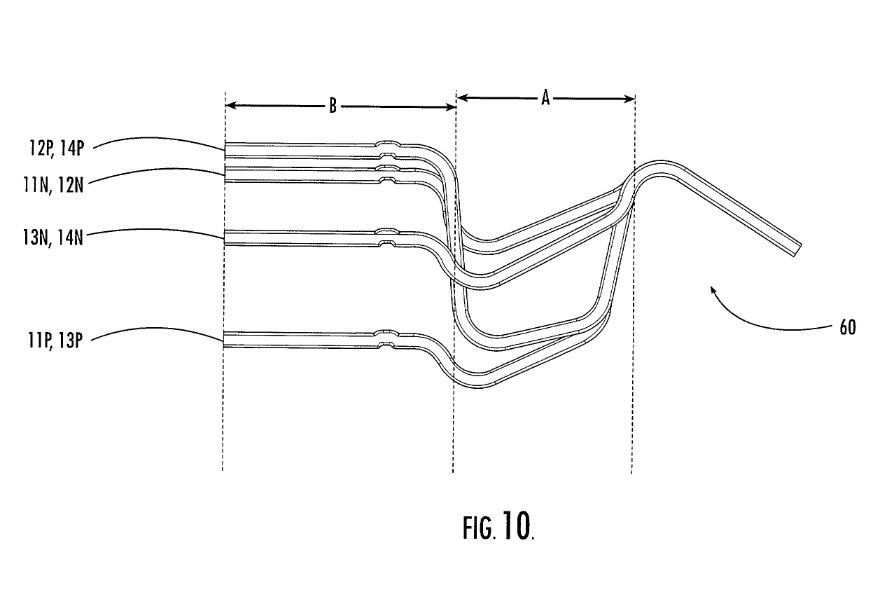

FIGS. 9 and 10 illustrate a contact array 60 to accomplish the above, with Pairs 1 (11N, 11P), 2 (12N, 12P), 3 (13N, 13P), and 4 (14N, 14P), as well as first and second inductive compensation zones “A”, “B” referenced therein.

An electrical connector having a contact array which provides inductive cross talk compensation is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

What is claimed is:

1. An array of electrical conductors, said array comprising:
an input zone, a first inductive cross talk compensation zone downstream from the input zone, and a second inductive cross talk compensation zone downstream from the first inductive cross talk compensation zone, wherein:
the first inductive cross talk compensation zone of the array is configured to induce corrective mutual inductance therein for reducing cross talk caused by undesirable mutual inductance in the input zone of the array; and
the second inductive cross talk compensation zone of the array is configured to induce corrective mutual inductance therein for reducing cross talk caused by undesirable mutual inductance in the input zone of the array and caused by undesirable mutual inductance in the first inductive cross talk compensation zone of the array.

2. An array according to claim 1, wherein the array is housed in a mated combination of a plug and a jack.

3. An array according to claim 1, wherein the input zone of the array comprises first, second, third, and fourth conductor pairs arranged in accordance with TIA specifications and the first and second inductive cross talk compensation zones of the array are configured to reduce cross talk between predetermined pairs of conductor pairs.

4. An array of electrical conductors, said array comprising:
an input zone, a first inductive cross talk compensation zone downstream from the input zone, and a second inductive cross talk compensation zone downstream from the first inductive cross talk compensation zone, wherein:
the first inductive cross talk compensation zone of the array is configured to induce corrective mutual inductance therein for reducing cross talk caused by undesirable mutual inductance in the input zone of the array; and
the second inductive cross talk compensation zone of the array is configured to induce corrective mutual inductance therein for reducing cross talk caused by undesirable mutual inductance in the input zone of the array and caused by undesirable mutual inductance in the first inductive cross talk compensation zone of the array;
the input zone of the array comprising first, second, third, and fourth conductor pairs arranged in accordance with TIA specifications and the first and second inductive cross talk compensation zones of the array are configured to reduce cross talk between predetermined pairs of conductor pairs;
wherein the array is housed in a mated combination of a plug and a jack.

5. A method for reducing undesirable inductive cross talk in an array of electrical conductors, said method comprising the steps of:
providing an array of electrical conductors;
configuring the array to comprise an input zone, a first inductive cross talk compensation zone downstream from the input zone, and a second inductive cross talk compensation zone downstream from the first inductive cross talk compensation zone;
configuring the first inductive cross talk compensation zone of the array to induce corrective mutual inductance therein for reducing cross talk caused by undesirable mutual inductance in the input zone of the array; and
configuring the second inductive cross talk compensation zone of the array to induce corrective mutual inductance therein for reducing cross talk caused by undesirable mutual inductance in the input zone of the array and caused by undesirable mutual inductance in the first inductive cross talk compensation zone of the array.

6. A method according to claim 5, wherein the array is housed in a mated combination of a plug and a jack.

7. A method according to claim 5, wherein the input zone of the array comprises first, second, third, and fourth conductor pairs arranged in accordance with TIA specifications and the first and second inductive cross talk compensation zones of the array are configured to reduce cross talk between predetermined pairs of conductor pairs.

8. A method for reducing undesirable inductive cross talk in an array of electrical conductors, said method comprising the steps of:
providing an array of electrical conductors;
configuring the array to comprise an input zone, a first inductive cross talk compensation zone downstream from the input zone, and a second inductive cross talk compensation zone downstream from the first inductive cross talk compensation zone;
configuring the first inductive cross talk compensation zone of the array to induce corrective mutual inductance therein for reducing cross talk caused by undesirable mutual inductance in the input zone of the array;
configuring the second inductive cross talk compensation zone of the array to induce corrective mutual inductance therein for reducing cross talk caused by undesirable mutual inductance in the input zone of the array and caused by undesirable mutual inductance in the first inductive cross talk compensation zone of the array; and wherein the input zone of the array comprises first, second, third, and fourth conductor pairs arranged in accordance with TIA specifications and the first and second inductive cross talk compensation zones of the array are configured to reduce cross talk between predetermined pairs of conductor pairs, and wherein the array is housed in a mated combination of a plug and a jack.

9. A method for reducing undesirable inductive cross talk in an array of electrical conductors, said method comprising the steps of:
providing an array of electrical conductors comprising an input zone, a first inductive cross talk compensation zone downstream from the input zone, and a second inductive cross talk compensation zone downstream from the first inductive cross talk compensation zone;
inducing undesirable cross talk in the input zone of the array;
inducing undesirable cross talk in the first inductive cross talk compensation zone of the array;
inducing corrective mutual inductance in the first inductive cross talk compensation zone for reducing cross talk caused by undesirable mutual inductance in the input zone of the array; and
inducing corrective mutual inductance in the second inductive cross talk compensation zone for reducing cross talk caused by undesirable mutual inductance in the input zone of the array and caused by undesirable mutual inductance in the first inductive cross talk compensation zone of the array.

10. A method according to claim 9, wherein the array is housed in a mated combination of a plug and a jack.

11. A method according to claim 9, wherein the input zone of the array comprises first, second, third, and fourth conductor pairs arranged in accordance with TIA specifications and the first and second inductive cross talk compensation zones of the array are configured to reduce cross talk between predetermined pairs of conductor pairs.

12. A method for reducing undesirable inductive cross talk in an array of electrical conductors, said method comprising the steps of:
providing an array of electrical conductors comprising an input zone, a first inductive cross talk compensation zone downstream from the input zone, and a second inductive cross talk compensation zone downstream from the first inductive cross talk compensation zone;
inducing undesirable cross talk in the input zone of the array;
inducing undesirable cross talk in the first inductive cross talk compensation zone of the array;
inducing corrective mutual inductance in the first inductive cross talk compensation zone for reducing cross talk caused by undesirable mutual inductance in the input zone of the array;
inducing corrective mutual inductance in the second inductive cross talk compensation zone for reducing cross talk caused by undesirable mutual inductance in the input zone of the array and caused by undesirable mutual inductance in the first inductive cross talk compensation zone of the array; and
wherein the input zone of the array comprises first, second, third, and fourth conductor pairs arranged in accordance with TIA specifications and the first and second inductive cross talk compensation zones of the array are configured to reduce cross talk between predetermined pairs of conductor pairs, and wherein the array is housed in a mated combination of a plug and a jack.
